(19) United States
(12) Patent Application Publication
(10) Pub. No.: US 2010/0138275 A1
(43) Pub. Date: Jun. 3, 2010

(54) AUTOMATIC EVENT SHIFTING OF DEMAND PATTERNS USING MULTI-VARIABLE REGRESSION

(76) Inventors: Arash Bateni, Toronto (CA); Edward Kim, Toronto (CA)

Correspondence Address: JAMES M. STOVER;TERADATA CORPORATION, 2835 MIAMI VILLAGE DRIVE, MIAMISBURG, OH, 45342, US

(21) Appl. No.: 12/327,068

(22) Filed: Dec. 3, 2008

(51) Int. Cl. G06Q 10/00

(52) U.S. Cl. 705/10

(57) ABSTRACT

A product demand forecasting technique is presented which employs multivariable regression analysis to identify demand associated with annual events and shift demand associated with those events when the events occur in different weeks of different years. Historical weekly product demand data is acquired for one or more years. An event influencing demand for products which occurs at in different weeks in a prior year than in the forecast year is identified. Mulitvariable regression techniques are used to analyze the historical weekly product demand data to determine demand components associated with the event. These demand components can then be removed from the historical weekly demand data and re-applied to weeks in the prior year corresponding to the week the event occurs in the forecast year to create a shifted historical weekly demand for said product.

### RELATED APPLICATIONS

This application claims priority under 35 U.S.C. §19(e) to the following co-pending and commonly-assigned patent applications, which are incorporated herein by reference:

Application Ser. No. 0/724,840, entitled “Methods and Systems for Forecasting Seasonal Demand for Products having Similar Historical Selling Patterns,” filed on Dec. 1, 2003, by Edward Kim, Roger Wu, Frank Luo and Andre Isler.

Application Ser. No. 11/472,007, entitled “Automatic Event Shifting of Demand Patterns Using Sphere of Influence Regression,” filed on Jun. 21, 2006, by Arash Bateni and Edward Kim.

### FIELD

The invention relates generally to demand forecasting and more particularly to techniques for retail demand forecasting with event shifting.

### BACKGROUND

Enterprises have been regularly collecting valuable electronic data from transactions with their consumers. This data has been indexed and stored in databases for subsequent mining and analysis. The mining and analysis can assist enterprises in allocating resources, revamping operations, introducing new products or services, increasing revenue, decreasing expenses, forecasting further sales, and the like.

One type of data collected relates to consumer demand for goods or services. The demand is historical in nature, meaning it has already occurred, but the demand may also be used to forecast future consumer activity. Analysis of demand patterns demonstrates that seasonal events, such as holidays, alter consumer demand for goods or services. One example of this is the Christmas holiday season, where most United States based retailers experience a majority of their sales during this particular holiday season.

The Christmas seasonal effect on retail demand can be easily identified from demand patterns occurring from the Thanksgiving holiday to Christmas day, December 25. But, other events that may affect demand patterns are not so easily identified. For example, the Easter holiday follows an ecclesiastical calendar and it may appear on different days and even within different months from year to year. Therefore, accounting for the seasonal effects of Easter within a corpus of demand data can be difficult.

Without the proper accounting of seasonal effects or societal events, the demand data can be skewed and present an inaccurate picture of demand for any given week or day within a calendar year. So, a week in one year may have a heavy demand for a product while the same week in other years may appear to be uninteresting. If the anomalous demand is not properly accounted for, then forecasting for that same week can become distorted, adversely affecting business projections and inventories.

Teradata Corporation has developed a suite of analytical applications for the retail business, referred to as Teradata Demand Chain Management (DCM), that provides retailers with the tools for product demand forecasting, planning and replenishment. As part of the Teradata DCM forecasting process, historical demand data is saved for each product or service offered by a retailer. This historical demand data, and other information derived therefrom, may be obtained for an individual product and also for all products within a merchandise group. The DCM application utilizes seasonal profiles that are typically calculated at an aggregated level or class of the merchandise or product hierarchy to adjust demand forecasts for seasonal variation. The seasonal profile, or model, for a product or product grouping is determined by calculating a Seasonal Factor for each week of the fiscal year.

Additional detail regarding the use of seasonal profiles and seasonal factors within the Teradata DCM application is provided in U.S. patent application Ser. No. 0/724,840, referred to above, and incorporated herein by reference.

The Teradata DCM application also includes an event shifting procedure for revising demand to compensate for demand values associated with holidays or other events that may appear on different days and even within different months from year to year. Additional detail regarding an automatic event shifting process for use within the Teradata DCM application id provided in U.S. patent application Ser. No. 11/472,007, referred to above, and incorporated herein by reference.

An improved approach for performing event shifting is presented herein. This approach, referred to herein as Regression Event Shift (RES), is believed to improve the accuracy of event shifting, and incorporates additional functionalities not provided by current methods.

### BRIEF DESCRIPTION OF THE DRAWINGS

FIGS. 1A-1C are example diagrams of Easter week demand patterns for three years, showing the holiday demand occurring in a different fiscal week of each year.

FIG. 2A is an diagram that shows the average demand calculated from the demand patterns of FIGS. 1A-1C, without any adjustment for when Easter occurs in each of the three years.

FIG. 2B is an diagram that shows a demand pattern calculated from the demand patterns of FIGS. 1A-1C, utilizing event shifting demand to place demand associated with the Easter holiday into the same calendar week.

FIG. 3 provides graph illustrating the historical weekly demand for an exemplary product during a prior-year fifty-two week period.

FIGS. 4A and 4B shows the event uplifts associated with events influencing product demand during a three week period including weeks 7, 8, and 9 (EVENT 1), and a three week period encompassing weeks 37, 38, and 39 (EVENT 2).

FIG. 5A provides a graph illustrating a revised weekly demand for the product of FIG. 3, following the removal of EVENT 1 and EVENT 2 demand components.

FIG. 5B provides a graph illustrating a re-eventized weekly demand for the product of FIG. 3, following the shift of EVENT 1 demand components a week earlier to weeks 6 through 7, and a shift of EVENT 2 demand components four weeks earlier to weeks 33 through 35.

FIGS. 6A and 6B each show a simplified example product hierarchy and the event definition levels for EVENT 1 and EVENT 2, respectively.

FIGS. 7A and 7B each show a simplified example product hierarchy and the regression event shift calculation levels for EVENT 1 and EVENT 2, respectively.

FIG. 8 is a simple graph illustrating the influence of seasonality and events on a product's demand pattern.

FIG. 9 is a simple flow chart illustrating a first implementation of the regression event shifting methodology into a forecasting process in accordance with the present invention.

FIG. 10 is a simple flow chart illustrating a second implementation of the regression event shifting methodology into a forecasting process in accordance with the present invention.

### DETAILED DESCRIPTION

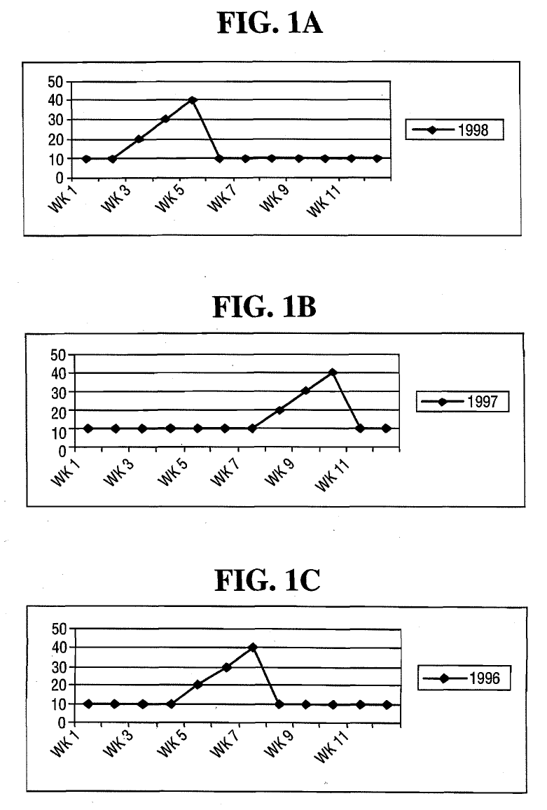

As stated above, the occurrence of certain annual events, such as holidays or sporting events, can alter the weekly demand for certain products or services. When these events occur in different weeks of different years, the task of forecasting future demand for these products and services from historical demand data becomes more difficult. FIGS. 1A through 1C provide an example of an event which often occurs in different weeks of different years.

FIGS. 1A-1C are example diagrams of Easter week demand patterns for three years, showing the holiday demand occurring in a different fiscal week of each year. FIG. 1A illustrates a sample graph depicting demand on the y axis and 13 weeks on the x axis that surround Easter for fiscal year 1998. Easter occurs during week 5 in 1998 and it can be seen that demand for a sample good substantially increases during weeks 3 through 5.

FIG. 1B illustrates another sample graph depicting demand over 13 weeks for fiscal year 1997. Here, Easter occurs in week 10. FIG. 1C illustrates yet another sample graph depicting demand over 13 weeks for fiscal year 1996. Here, Easter occurs in week 7.

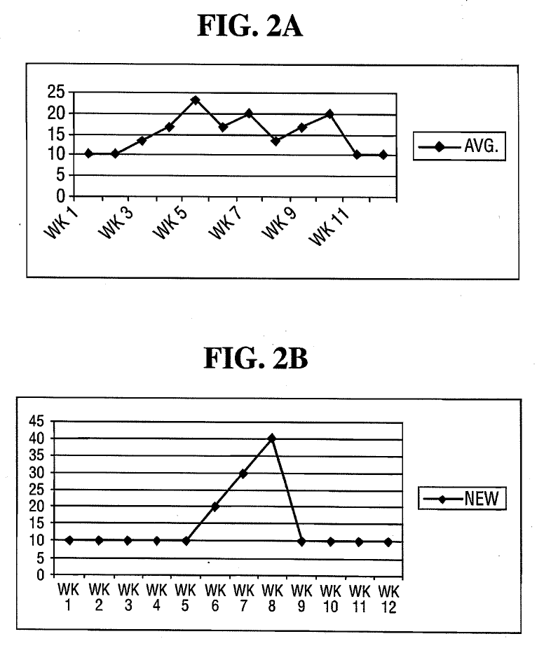

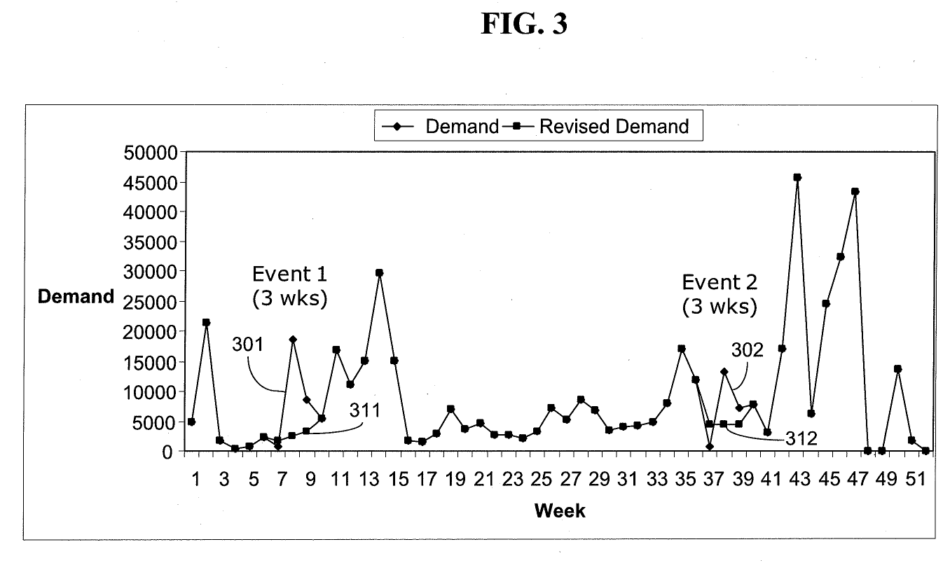

FIG. 2A illustrates a graph that simply averages the demand without any adjustment for when Easter occurs in each of the three years. It can be seen that there are three distinct demand spikes in FIG. 3.

Finally, FIG. 2B illustrates a graph that utilizes an event shifting process for aligning historical demand increases associated with the Easter holiday to place demand associated with the Easter holiday into the same calendar week. In FIG. 2B, Easter was determined for some future year, where Easter occurs in week 9. It can be seen that there are not three spikes, as shown in FIG. 2A. Rather, there is one spike depicting projected the future demand for Easter based on fiscal years 1996-1998. It is clear that the, event shifting demand pattern presents a more accurate forecast to retailers than a simple and traditional averaging approach.

The Regression Event Shift (RES) methodology for event shifting models a product's or product group's demand pattern using multi-variable regression, such that event flags are predictors and product demand is the response variable: dmnd=F(events). A typical regression equation is shown below:

$$dmnd = α \cdot {price}^{β} \cdot {e}^{γ \cdot promo} \cdot {e}^{{\sum }_{k}^{ } {λ}_{k} \cdot {event}_{k}}$$

$$log dmnd = log α + β \cdot log price + γ \cdot promo + {\sum }_{k}^{ } {λ}_{k} \cdot {event}_{k}$$

The regression equation describes the effect of each event on the product demand, in terms of event uplifts: exp(λk). Easter and other annual events that occur in different weeks in different years are each represented as a different event in the regression equation. RES event shifting can then be performed using the corresponding event uplifts to de-eventize the actual demand, and then re-eventize the demand at the desired target week. Demand is de-eventized by dividing the actual demand by the event uplift, and re-eventized by applying the event uplift at the target event week.

The process of de-eventizing and re-eventizing demand is illustrated in the graphs shown in FIGS. 3, 4A, 4B, 5A and 5B. FIG. 3 provides a graph illustrating the historical weekly demand for an exemplary product during a prior-year fifty-two week period. The demand pattern shown in the graph includes two three-week periods wherein a component of the illustrated demand is associated with an event that requires shifting during the product demand forecasting process. The first event, EVENT 1, affects weeks 7, 8 and 9, and the second event, EVENT 2, affects weeks 37, 38 and 39. The graph, including segments 301 and 302, of FIG. 3 shows the actual demand for a product, including the EVENT 1 and EVENT 2 demand influences at weeks 7-9, and 37-39, respectively. A revised demand, wherein the demand influences of EVENT 1 and EVENT 2 have been removed, is illustrated by the graph including segments 311 and 312.

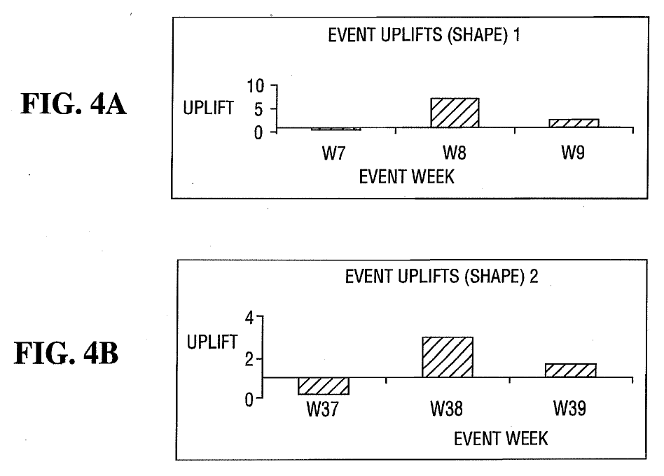

FIG. 4A shows the event uplifts associated with EVENT 1 for weeks 7, 8, and 9. FIG. 4B shows the event uplifts associated with EVENT 2 for weeks 37, 38, and 39.

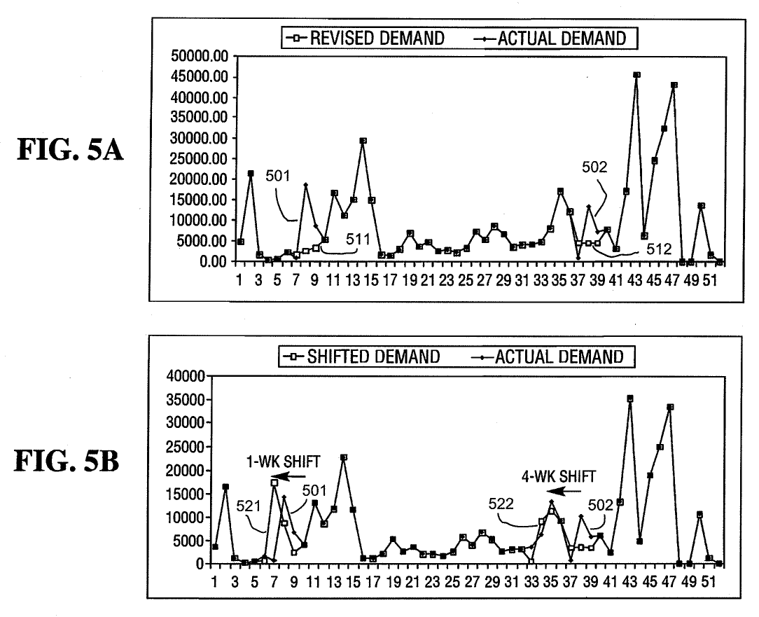

FIG. 5A provides a graph illustrating a revised weekly demand for the product of FIG. 3, following the removal of EVENT 1 and EVENT 2 demand influences. This revised, or de-eventized, demand Drev is calculated by dividing the original total product demand D for each week, illustrated in FIG. 3, by the corresponding weekly event uplift, Uplift, associated with EVENT 1 and EVENT 2: event uplifts: Drev=D/Uplift. The only differences between the actual total product demand and the revised demand is seen at weeks 7-9 and 37-39. The graph, including segments 501 and 502, of FIG. 5 shows the actual demand for a product. The revised demand, wherein the demand influences of EVENT 1 and EVENT 2 have been removed, is illustrated by the graph including segments 511 and 512.

In FIG. 5B, the demand graph has been re-eventized to shift EVENT 1 demand one week earlier to weeks 6 through 7, and to shift EVENT 2 demand four weeks earlier to weeks 33 through 35. The shift is accomplished by applying the event uplifts associated with EVENT 1 and EVENT 2 to the desired target weeks in accordance with the equation Dshift=Drev*Uplift. The shifted demand is illustrated by the graph including segments 521 and 522 at weeks 6-9 and 33-39, respectively.

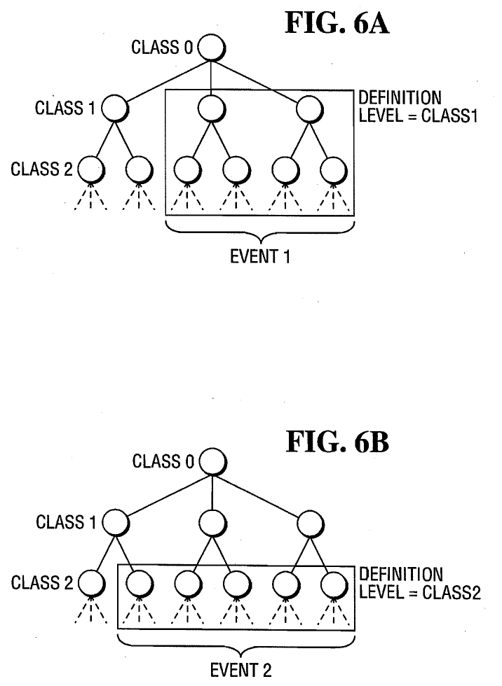

Events and event uplifts can be defined and determined for individual products, product groups, or levels within a product hierarchy. FIGS. 6A and 6B show a simplified example product hierarchy. Three levels of a product hierarchy are illustrated, with each lower level in the hierarchy containing more specific product groupings. The topmost level of the hierarchy, CLASS 0, includes the broad product categories, such as women's wear. The second level of the hierarchy, identified as CLASS 1, include more specific product groupings under the CLASS 1 category, such as women's outerwear, women's sleepwear, and women's accessories. CLASS 3 includes even more specific product groupings under the CLASS 2 product groups, such as women's coats and women's 227, Women's Blouses 228 and Women's Slacks. Additional, more specific, merchandise class categories may be included below CLASS 3. All products offered for sale by the retailer are represented within at least one of the lowest level merchandise class categories within the merchandise hierarchy.

Additional detail concerning product hierarchies is provided in U.S. patent application Ser. No. 0/724,840, referred to above, and incorporated herein by reference.

The RES methodology is flexible with respect to event definition levels. Events can be defined at any level, given that all products under that level are affected by the event. Generally, it is more convenient to define events at the highest possible level. In FIG. 6A, the event definition level for EVENT 1 is shown to be at CLASS 1. In FIG. 6B, the event definition level for EVENT 2 is shown to be at CLASS 2.

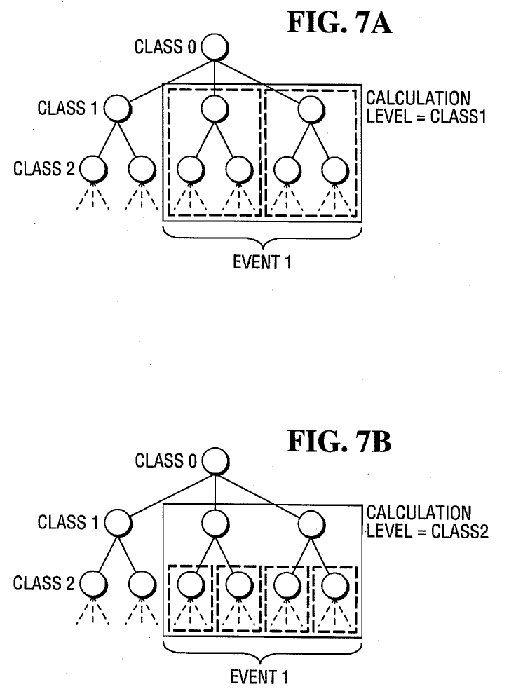

FIGS. 7A and 7B show the RES calculation levels corresponding to EVENT 1 and EVENT 2. Calculation level is the level of hierarchy at which the regression model is created. All the products below the calculation level are assumed to be: a) similarly influenced by the event, and b) have similar seasonality. Enough data should be available at the calculation level, to perform the regression analysis, otherwise, aggregation to higher levels will be required.

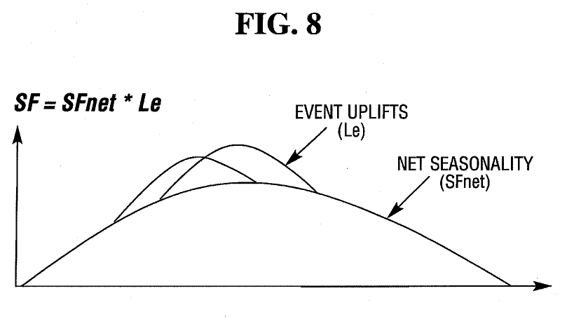

FIG. 8 illustrate the influence of seasonality and events on the product demand pattern. Currently in the Teradata DCM application seasonal factors (SF) account for both the underlying seasonality and the influence of the events. Employing the RES methodology allows a decoupling of seasonal factors into two components: net seasonality (SFnet) and event uplifts (Le). In order to better account for the influence of events, the effect of events can be removed using RES to determine the net seasonality, and the event uplifts applied at the proper point in the demand pattern during forecast calculation.

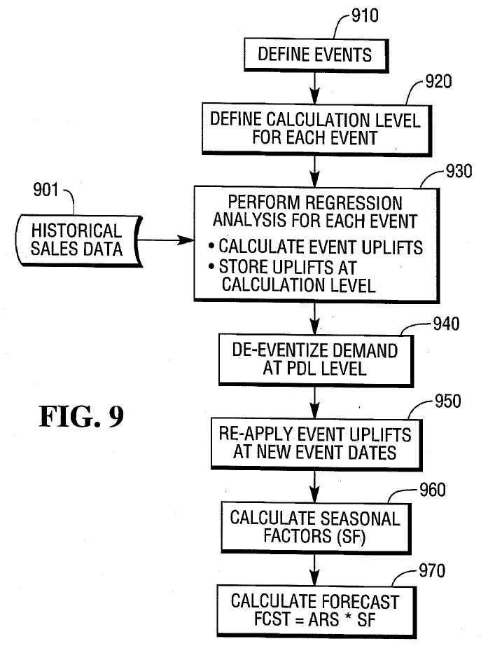

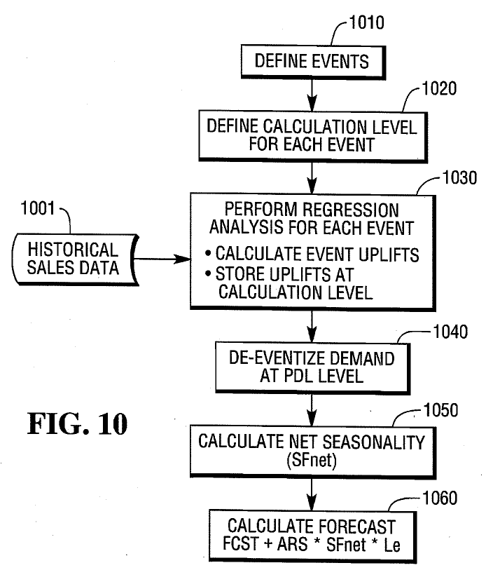

The flow charts of FIGS. 9 and 10 illustrate two implementations of the RES methodology into the Teradata DCM demand forecasting process. As part of the DCM demand forecasting process, historical sales data is saved for each product or service offered by a retailer. The database of historical sales data is represented by data store 901 and 1001 in FIGS. 9 and 10, respectively. In the implementation shown in FIG. 9 event uplifts are calculated and used to shift the demand, and seasonal factors calculated from the shifted demand patterns. This implementation of the RES methodology requires minimum change compared to the current DCM forecasting system, but requires seasonal factors (SFs) to be recalculated when event dates are stale. Referring to FIG. 9, the process as shown begins with step 910 wherein events are defined, as explained above with reference to FIGS. 6A and 6B. In step 920 the calculation levels for each event are defined, as explained above with reference to FIGS. 7a and 7B.

Regression analysis is performed on historical sales data drawn from data store 901 to determine the event uplifts for each event in step 930. The event uplifts are used to de-eventized the historical product demand in step 940. In step 950 the event uplifts are re-applied at new event dates corresponding to the dates these events will occur during the forecast period to create a revised historical product demand.

Utilizing the revised historical demand, seasonal factors (SF) are calculated in step 960. In step 970 the seasonal factors are applied to product average rate of sales (ARS) values generated by the Teradata DCM application to determine the seasonal demand forecast (FCST) for products.

The implementation shown in FIG. 10 does not shift or revise historical product demand. It calculates net seasonality based on de-eventized demand, then applies the event uplifts at the forecasting step. This implementation of the RES methodology within the forecasting process does not require seasonal factors to be recalculated when event dates are stale, since net seasonal factors are calculated independent of events. Referring to FIG. 10, the process as shown begins with steps 1010 and 1020 wherein events are defined, and the calculation levels for each event are set.

In step 1030 regression analysis is performed on historical sales data drawn from data store 1001 to determine the event uplifts for each defined event. The event uplifts are used to de-eventized the historical product demand in step 1040.

Utilizing the de-eventized historical demand, net seasonal factors (SFnet) are calculated in step 1050. The net seasonal factors are calculated from demand data after removal of demand components associated with the defined events. In step 10670 the event uplifts (Le) and net seasonal factors (SFnet) are applied to product average rate of sales (ARS) values generated by the Teradata DCM application to determine the seasonal demand forecast (FCST) for products.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method for forecasting product demand for a product in a forecast year, the method comprising the steps of:
storing within a data warehouse historical demand data for a product;
identifying an event influencing demand for said product, said event occurring at a different period of time in a prior year than in said forecast year;
analyzing said historical demand data for said product to determine a demand component associated with said event;
removing from said historical demand data said demand component associated with said event;
re-applying said demand component associated with said event to a period of time in said prior year corresponding to the period of time said event occurs in said forecast year to create a shifted historical demand for said product; and
calculating a forecast demand for said product from said shifted historical demand for said product.

2. The method for forecasting product demand for a product in a forecast year in accordance with claim 1, wherein said step of analyzing said historical demand data for said product to determine a demand component associated with said event comprises the step of:
modeling demand for said product using a multi-variable regression equation wherein said demand component associated with said event is represented in said regression equation by the product of an event uplift and an event flag.

3. A method for forecasting product demand for a plurality of products in a forecast year, the method comprising the steps of:
storing within a data warehouse historical demand data for a plurality of products;
identifying an event influencing demand for said plurality of products, said event occurring at a different period of time in a prior year than in said forecast year;
analyzing said historical demand data for said plurality of products to determine a demand component associated with said event;
removing from said historical demand data said demand component associated with said event;
re-applying said demand component associated with said event to a period of time in said prior year corresponding to the period of time said event occurs in said forecast year to create a shifted historical demand for said plurality of products; and
calculating a forecast demand for said plurality of products from said shifted historical demand for said plurality of products.

4. The method for forecasting product demand for a plurality of products in a forecast year in accordance with claim 3, wherein said plurality of products comprises all products within a product group within a product hierarchy.

5. A method for forecasting product demand for a product in a forecast year, the method comprising the steps of:
storing within a data warehouse historical weekly demand data for a product;
identifying an event influencing demand for said product, said event occurring at a different week in a prior year than in said forecast year;
analyzing said historical weekly product demand data for said product to determine a demand component associated with said event;
removing from said historical weekly demand data said demand component associated with said event;
re-applying said demand component associated with said event a week in said prior year corresponding to the week said event occurs in said forecast year to create a shifted historical weekly demand for said product; and
calculating a weekly demand forecast for said product from said shifted historical weekly demand for said product.

6. The method for forecasting product demand for a product in a forecast year in accordance with claim 5, wherein said step of analyzing said historical weekly demand data for said product to determine a demand component associated with said event comprises the step of:
modeling weekly demand for said product using a multi-variable regression equation wherein said demand component associated with said event is represented in said regression equation by the product of an event uplift and an event flag.

7. The method for forecasting product demand for a product in a forecast year in accordance with claim 6, wherein
said step of removing from said historical weekly demand data said demand component associated with said event comprises removing the product of said event uplift and said event flag from the regression equation for the week said event occurs in said prior year and calculating; and
said step of re-applying said demand component associated with said event a week in said prior year corresponding to the week said event occurs in said forecast year comprises adding the product of said event uplift and said event flag removed from the regression equation for the week said event occurs in said prior year to the regression equation for the week in said prior year corresponding to the week said event occurs in said forecast year.

8. A method for forecasting product demand for a product in a forecast year, the method comprising the steps of:
storing within a data warehouse historical weekly demand data for a product;
identifying an event influencing demand for said product, said event occurring at a different week in a prior year than in said forecast year;
analyzing said historical weekly product demand data for said product to determine a demand component associated with said event;
removing from said historical weekly demand data said demand component associated with said event;
re-applying said demand component associated with said event a week in said prior year corresponding to the week said event occurs in said forecast year to create a shifted historical weekly demand for said product;
creating a season profile from said product from said shifted historical weekly demand for said product, said seasonal profile comprising a series of weekly seasonal factors; and
calculating a weekly demand forecast for said product from said seasonal factors and an average weekly sales value for said product.

9. A method for forecasting product demand for a product in a forecast year, the method comprising the steps of:
storing within a data warehouse historical weekly demand data for a product;
identifying an event influencing demand for said product, said event occurring at a different week in a prior year than in said forecast year;
analyzing said historical weekly product demand data for said product to determine a demand component and event uplift factor associated with said event;
removing from said historical weekly demand data said demand component associated with said event to create a revised historical weekly demand for said product;
creating a season profile from said product from said revised historical weekly demand for said product, said seasonal profile comprising a series of weekly seasonal factors; and
calculating a weekly demand forecast for said product from said seasonal factors, an average weekly sales value for said product, and said event uplift factor.
